(19) United States
(12) Patent Application Publication
(10) Pub. No.: US 2002/0105914 A1
(43) Pub. Date: Aug. 8, 2002

(54) Method and apparatus for setting system time out values in a nodally networked system

(75) Inventor: Mike Conrad Duron, Pflugerville, TX (US)

Correspondence Address: Duke W. Yee, Carstens, Yee & Cahoon, LLP, P.O. Box 802334, Dallas, TX, 75380, US

(73) Assignee: International Business Machines Corporation Armonk, New York

(21) Appl. No.: 09/779,359

(22) Filed: Feb. 8, 2001

(51) Int. Cl. H04L 12/26

(52) U.S. Cl. 370/252

(57) ABSTRACT

A method, apparatus, and computer implemented instructions for setting a time out value. A path is identified from a set of paths from the data processing system to a destination to form an identified path, wherein the identified path has a largest latency in the set of paths. The data is routed to the destination using the identified path. The latency is measured for the data sent on the identified path to form a measured latency. The time out value is set using the measured latency, wherein the time out value is used to initiate a computer implemented process.

### BACKGROUND OF THE INVENTION

1. Technical Field

The present invention relates generally to an improved data processing system, and in particular to a method and apparatus for setting time out values in a network data processing system.

2. Description of Related Art

A network data processing system is a system that transmits any combination of voice, video and/or data between users. This system includes the cables and all supporting hardware such as bridges, routers and switches. In wireless systems, antennas and towers are also part of the network. Examples of network data processing systems include a local area network (LAN), a wide area network (WAN), and the Internet. A LAN is a communications network that serves users within a confined geographical area. It is made up of servers, workstations, a network operating system and a communications link. Servers are high-speed machines that hold programs and data shared by network users. The workstations (clients) are the users' personal computers, which perform stand-alone processing and access the network servers as required. A WAN is a communications network that covers a wide geographic area, such as state or country. In contrast, a LAN is contained within a building or complex. Within these network data processing systems are nodes, which provide a point for data transfer or reception. A node may be, for example, a switch, a router, or a computer.

Many server and computer designs are based on network data processing systems in which the nodes are interconnected in a ring or a grid or a mesh of sorts. Each node will have a primary and an alternate path for data. The alternate path is typically used if the primary path, usually the most direct path, is or becomes defective. All nodes have registers, which hold time out values so as to alert the user if a transaction does not complete in a reasonable amount of time. The design is such that the user will be notified, via an error message, if a transaction is not completed within the time set in the “time out value registers”. This system presents a problem in the development of network data processing systems to figure out just exactly what value to set in these timers. If the value is set too high, then a network data processing system is essentially hung until the timer expires. If the value is set too low, then transactions that generally take longer to complete, will not be able to complete because the time will expire.

Therefore, it would be advantageous to have an improved method and apparatus for setting time out values for use in a network data processing system.

### SUMMARY OF THE INVENTION

The present invention provides a method, apparatus, and computer implemented instructions for setting a time out value. A path is identified from a set of paths from the data processing system to a destination to form an identified path, wherein the identified path has a largest latency in the set of paths. The data is routed to the destination using the identified path. The latency is measured for the data sent on the identified path to form a measured latency. The time out value is set using the measured latency, wherein the time out value is used to initiate a computer implemented process.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram of nodes in a network data processing system in accordance with a preferred embodiment of the present invention;

FIG. 5 is a flowchart of a process used for identifying a time out value in accordance with a preferred embodiment of the present invention; and

FIG. 6 is a flowchart of a process used for setting a time out value from a measured latency in accordance with a preferred embodiment of the present invention.

### DETAILED DESCRIPTION OF THE PREFERRED EMBODIMENT

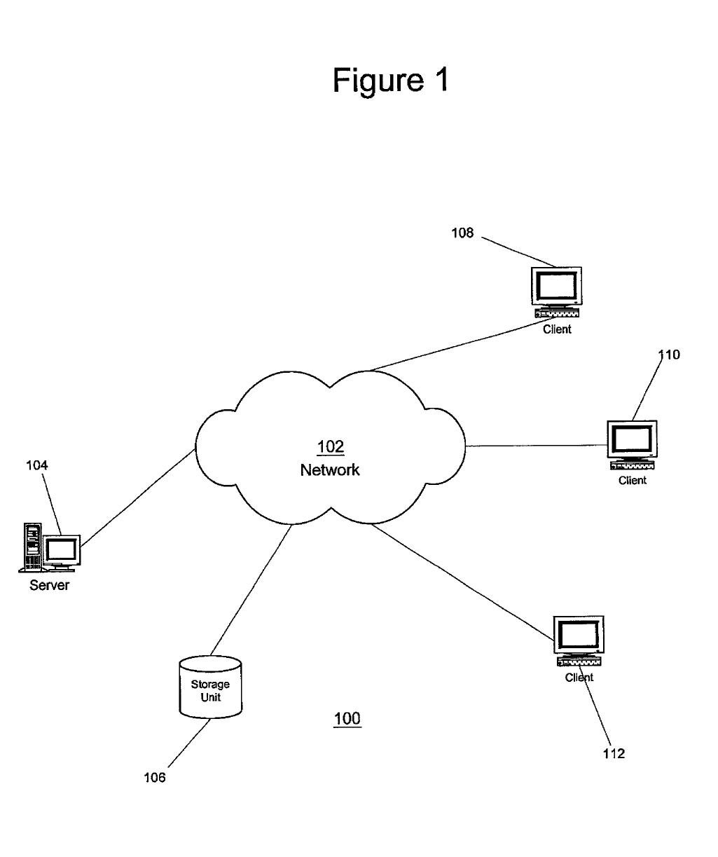

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

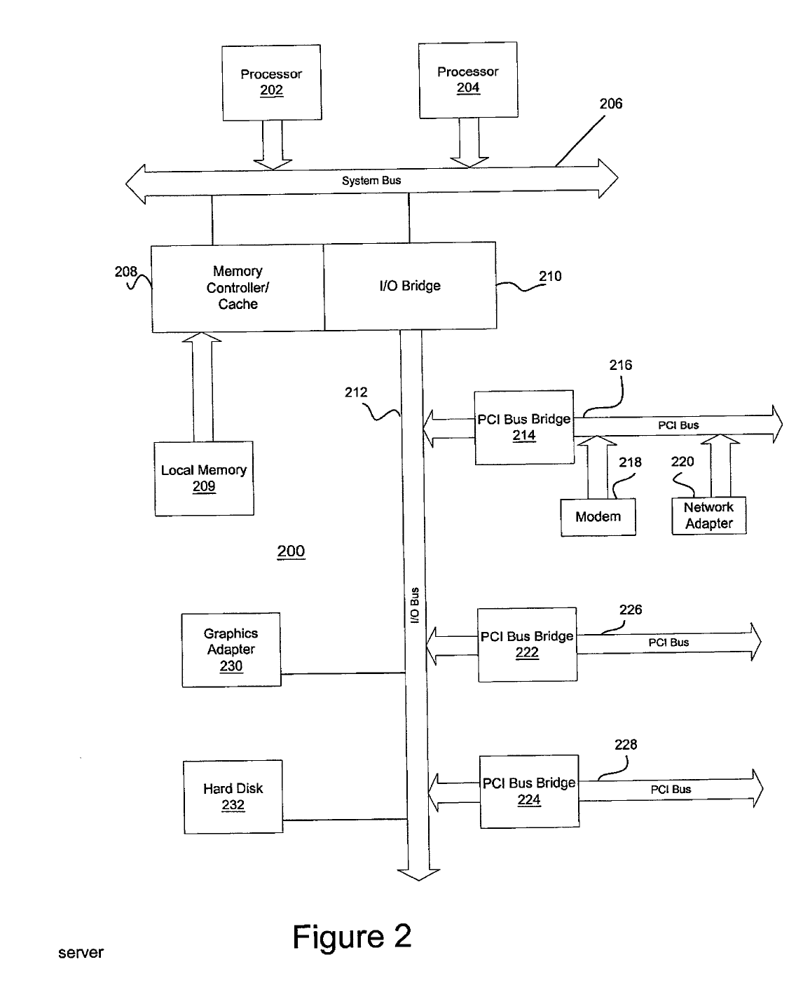

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

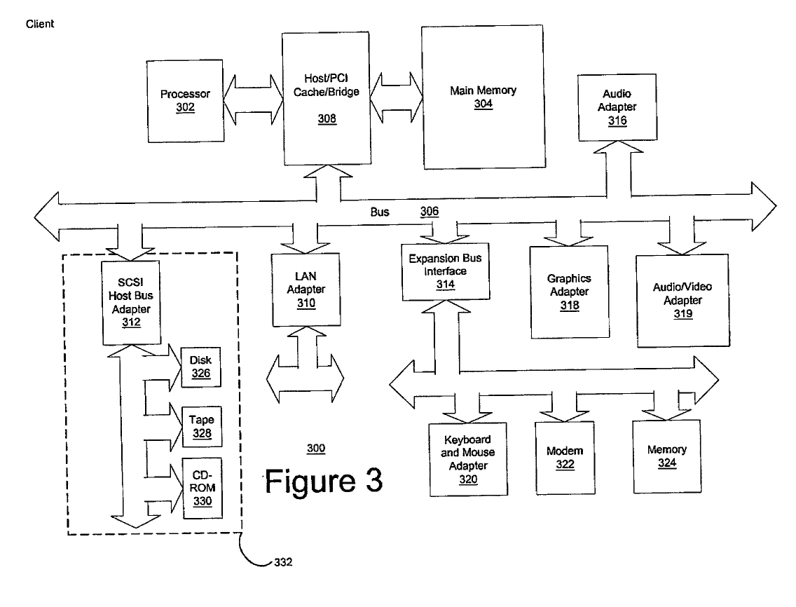

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

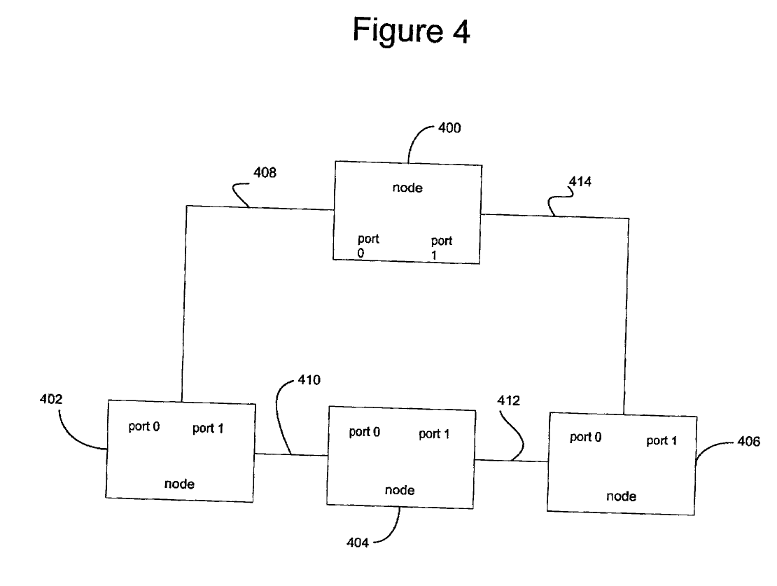

Turning next to FIG. 4, a diagram of nodes in a network data processing system is depicted in accordance with a preferred embodiment of the present invention. In this example, nodes 400, 402, 404, and 406 are interconnected by communications links 408, 410, 412, 414. These nodes may be implemented using a switch, a router, or a computer. In the form of a computer, the nodes may be implemented using data processing system 200 in FIG. 2 or data processing system 300 in FIG. 3. These nodes are depicted to illustrate a mechanism for setting time out values in which a worse case latency in transfer of data is taken into account without setting values that are excessive. These values are set to avoid premature timer expirations, hang like conditions, and mis-localization of a technical problem.

The solution involves configuring a routing of data so that data travels from a source to a destination through the longest path having the most latency. Latency is the time between initiating a request for data and the beginning of the actual data transfer. On a disk, latency is the time it takes for the selected sector to come around and be positioned under the read/write head. Channel latency is the time it takes for a computer channel to become unoccupied in order to transfer data. Network latency is the delay introduced when a packet is momentarily stored, analyzed and then forwarded.

In the depicted examples, if data is routed from node 400 to node 406, then data traveling from node 400 through nodes 402 and node 404 to node 406 travels along a path including communications links 408, 410, and 412. This path has the most latency in this example. Routing data from node 400 to node 406 through communications link 414 is the most direct path between these two nodes. Of course, the most direct path could have a longer latency if communications link 414 employs a different technology than communications links 408, 410, and 412.

With the routing of data through this longer path, latency values are measured for the path. Alternatively, latency values could be measured for each path between the source and destination. The longest measured latency value is then used in setting the time out value.

In the depicted examples, a time period is added to these latency values. More specifically, in the examples involve calculating the time period as a percentage of the measured latency.

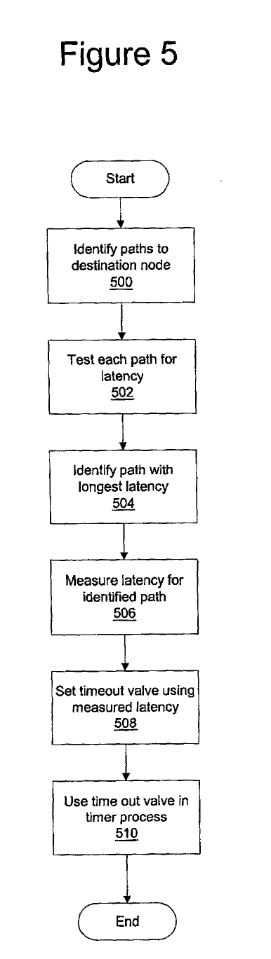

With reference now to FIG. 5, a flowchart of a process used for identifying a time out value is depicted in accordance with a preferred embodiment of the present invention. The process illustrated in FIG. 5 may be implemented in a node, such as node 400 in FIG. 4.

The process begins with the identification of the paths to a destination node (step 500). Each path is tested for latency (step 502). The path with the longest latency is then identified (step 504). Next, the latency is measured for the identified path (step 506). A time out value is set using the measured latency (step 508). The time out value is then used in a timer process (step 510) with the process terminating thereafter.

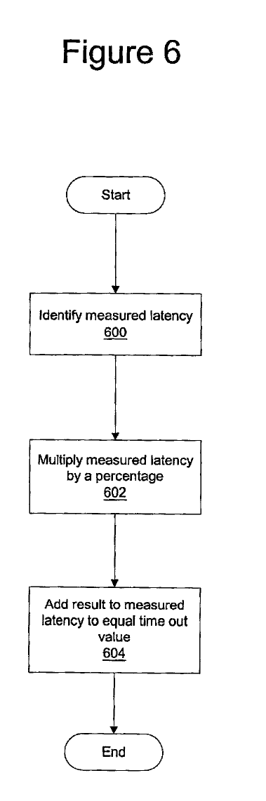

Turning now to FIG. 6, a flowchart of a process used for setting a time out value from a measured latency is depicted in accordance with a preferred embodiment of the present invention. The process illustrated in FIG. 6 is a more detailed description of step 508 in FIG. 5.

The process begins with an identification of a measured latency (step 600). Next, the measured latency is multiplied by a percentage (step 602). In these examples, the intention of the percentage is to allow some design margin to account for the quality of the physical medium used to link the nodes. For example, if the medium is a copper conductor cable, then the factors would include cable length, connector type, and any other physical attributes that make up the electrical characteristics of the medium. This margin also includes the cable driving circuitry within the node. The result is added to the measured latency to equal a timeout value (step 604) with the process terminating thereafter.

In this manner, more accurate timer values are selected. This allows avoiding premature indication of an error condition because a timer process prematurely expired. Further, using the mechanism of the present invention, the timer process expires within a reasonable amount of time after the worst case known latency value is reached. This allows more accuracy in localization and isolation processes, which rely on these time out values being accurate.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for setting a time out value, the method comprising:
identifying a path from a set of paths from the data processing system to a destination to form an identified path, wherein the identified path has a largest latency in the set of paths;
routing data to the destination using the identified path;
measuring latency for the data sent on the identified path to form a measured latency; and
setting the time out value using the measured latency, wherein the time out value is used to initiate a computer implemented process.

2. The method of claim 1, wherein the step of setting the time out value using the measured latency comprises:
adding a period of time to the measured latency to set the time out value.

3. The method of claim 1, wherein the period of time is a percentage of the measured latency.

4. The method of claim 1, wherein the destination is a data processing system.

5. The method of claim 1, wherein the destination is a router.

6. The method of claim 1, wherein the destination is a switch.

7. The method of claim 1, wherein the data processing system a switch.

8. The method of claim 1, wherein the identifying, routing measuring, and setting steps are performed in response to an event.

9. The method of claim 8, wherein the event is a periodic event.

10. The method of claim 1, wherein the time out value is used in the data processing system and the destination.

11. The method of claim 1, wherein the computer implemented process is an error detection process.

12. The method of claim 1, wherein the computer implemented process is a timer process in the data processing system.

13. A method in a data processing system for setting a time out value, the method comprising:
sending data on a particular path within a plurality of paths to a destination, wherein the particular path has a longest latency of within the plurality of paths;
measuring a time for the data to reach the destination to form a measured time; and
setting a time out value using the measured time.

14. The method of claim 13, wherein the step of setting a time out value comprises:
adding a period of time to the measured time.

15. The method of claim 14, wherein the period of time is a percentage of the measured time.

16. A network data processing system comprising:
a network;
a destination node connected to the network; and
a source node connected to the network in which a plurality of paths are present from the source node to the destination node, wherein the source node routes data to the destination node through a selected path within the plurality of paths in which the selected path has a longest latency period, measuring latency of the data routed from the source node to the destination node to form a measured latency, and setting a time out value for a node using the measured latency.

17. The network data processing system of claim 16, wherein the node is one of the destination nodes and the source node.

18. The network data processing system of claim 16, wherein the source node is a computer.

19. A data processing system for setting a time out value, the data processing system comprising:
identifying means for identifying a path from a set of paths from the data processing system to a destination to form an identified path, wherein the identified path has a largest latency in the set of paths;
routing means for routing data to the destination using the identified path;
measuring means for measuring latency for the data sent on the identified path to form a measured latency; and
setting means for setting the time out value using the measured latency, wherein the time out value is used to initiate a computer implemented process.

20. The data processing system of claim 19, wherein the setting means comprises:
adding means for adding a period of time to the measured latency to set the time out value.

21. The data processing system of claim 19, wherein the period of time is a percentage of the measured latency.

22. The data processing system of claim 19, wherein the destination is a data processing system.

23. The data processing system of claim 19, wherein the destination is a router.

24. The data processing system of claim 19, wherein the destination is a switch.

25. The data processing system of claim 19, wherein the data processing system a switch.

26. The data processing system of claim 19, wherein the identifying, routing measuring, and setting steps are performed in response to an event.

27. The data processing system of claim 26, wherein the event is a periodic event.

28. The data processing system of claim 19, wherein the time out value is used in the data processing system and the destination.

29. The data processing system of claim 19, wherein the computer implemented process is an error detection process.

30. The data processing system of claim 19, wherein the computer implemented process is a timer process in the data processing system.

31. A data processing system for setting a time out value, the data processing system further comprising:
sending means for sending data on a particular path within a plurality of paths to a destination, wherein the particular path has a longest latency of within the plurality of paths;
measuring means for measuring a time for the data to reach the destination to form a measured time; and
setting means for setting a time out value using the measured time.

32. The data processing system of claim 31, wherein the setting means comprises:
adding means for adding a period of time to the measured time.

33. The data processing system of claim 32, wherein the period of time is a percentage of the measured time.

34. A data processing system comprising:
a bus system;
a communications unit connected to the bus system;
a memory connected to the bus system, wherein the memory includes as set of instructions; and
a processing unit connected to the bus system, wherein the processing unit executes the set of instructions to identify a path from a set of paths from the data processing system to a destination to form an identified path, wherein the identified path has a largest latency in the set of paths; route data to the destination using the identified path using the communications unit; measure latency for the data sent on the identified path to form a measured latency; and set a time out value using the measured latency, wherein the time out value is used to initiate a computer implemented process.

35. The data processing system of claim 34, wherein the bus system is a single bus.

36. The data processing system of claim 34, wherein the bus system includes a primary bus and a secondary bus.

37. The data processing system of claim 34, wherein the processing unit includes a plurality of processors.

38. The data processing system of claim 34, wherein the communications unit is one of a modem and Ethernet adapter.

39. A data processing system comprising:
a bus system;
a communications unit connected to the bus system;
a memory connected to the bus system, wherein the memory includes as set of instructions; and
a processing unit connected to the bus system, wherein the processing unit executes the set of instructions to send data on a particular path within a plurality of paths to a destination using the communications unit, wherein the particular path has a longest latency of within the plurality of paths; measure a time for the data to reach the destination to form a measured time; and set a time out value using the measured time.

40. The data processing system of claim 39, wherein the bus system is a single bus.

41. The data processing system of claim 39, wherein the bus system includes a primary bus and a secondary bus.

42. The data processing system of claim 39, wherein the processing unit includes a plurality of processors.

43. The data processing system of claim 39, wherein the communications unit is one of a modem and Ethernet adapter.

44. A computer program product in a computer readable medium for setting a time out value, the computer program product comprising:
first instructions for identifying a path from a set of paths from the data processing system to a destination to form an identified path, wherein the identified path has a largest latency in the set of paths;
second instructions for routing data to the destination using the identified path;
third instructions for measuring latency for the data sent on the identified path to form a measured latency; and
fourth instructions for setting the time out value using the measured latency, wherein the time out value is used to initiate a computer implemented process.

45. A computer program product in a computer readable medium for setting a time out value, the computer program product comprising:
first instructions for sending data on a particular path within a plurality of paths to a destination, wherein the particular path has a longest latency of within the plurality of paths;
second instructions for measuring a time for the data to reach the destination to form a measured time; and
third instructions for setting a time out value using the measured time.
